(19) United States
(12) Patent Application Publication
(10) Pub. No.: US 2025/0284140 A1
(43) Pub. Date: Sep. 11, 2025

(54) SUBSTRATE-LEVEL MONOLITHIC INTEGRATION OF PRESCRIPTION LENS WITH AUGMENTED REALITY (AR) WAVEGUIDES

(71) Applicant: Applied Materials, Inc., Santa Clara, CA (US)

(72) Inventors: Namho KIM, Sunnyvale, CA (US); Ludovic GODET, Sunnyvale, CA (US); Yingdong LUO, Newark, CA (US); Zhengping YAO, Cupertino, CA (US); Daihua ZHANG, Los Altos, CA (US)

(21) Appl. No.: 19/068,443

(22) Filed: Mar. 3, 2025

Related U.S. Application Data
(60) Provisional application No. 63/563,711, filed on Mar. 11, 2024.

(51) Int. Cl. G02C 7/02; B29D 11/00; G02B 27/01

(52) U.S. Cl. CPC G02C 7/022; B29D 11/00355; B29D 11/00442; G02B 27/0172

(57) ABSTRACT

Embodiments described herein relate to AR waveguides with attached prescription lenses. In one embodiment, an eye-piece is provided. The eye-piece includes a waveguide, a convex prescription lens, a first gap, a concave prescription lens, and a second gap. The waveguide includes a substrate with a first surface and a second surface. The convex prescription lens is disposed over the waveguide on the first surface. The convex prescription lens has a first body with a convex surface and a lower surface. The first gap is defined by the lower surface and a first extension of the convex prescription lens. The concave prescription lens is disposed over the waveguide on the second surface. The concave prescription lens has a second body with a concave surface and an upper surface. The second gap is defined by the upper surface and a second extension of the concave prescription lens.

### CROSS-REFERENCE TO RELATED APPLICATIONS

This application claims benefit of U.S. provisional patent application Ser. No. 63/563,711, filed Mar. 11, 2024, which is herein incorporated by reference.

### BACKGROUND

### Field

Embodiments of the present disclosure generally relate to augmented reality (AR) displays. More specifically, embodiments described herein relate to AR waveguides with attached prescription lens.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality (AR), however, enables an experience in which a user can still see through the display lenses of the glasses or other HMD device to view the surrounding environment, yet also see images of virtual objects that are generated to appear as part of the environment. Augmented reality can include any type of input, such as audio and haptic inputs, as well as virtual images, graphics, and video that enhance or augment the environment that the user experiences. Users that require prescription eye glasses will still need a prescription lens to clearly see the surrounding environment. Therefore, what is needed in the art are AR waveguides with attached prescription lenses.

### SUMMARY

In one embodiment, an eye-piece is provided. The eye-piece includes a waveguide, a convex prescription lens, a first gap, a concave prescription lens, and a second gap. The waveguide includes a substrate with a first surface and a second surface, and at least one grating is disposed over the first surface or the second surface. The convex prescription lens is disposed over the waveguide. The convex prescription lens has a first body with a convex surface and a lower surface. The first body is surrounded by a first extension that is disposed on the first surface of the substrate. The first gap is defined by the lower surface and the first extension of the convex prescription lens. The concave prescription lens is disposed over the waveguide. The concave prescription lens has a second body with a concave surface and an upper surface. The second body is surrounded by a second extension that is disposed on the second surface of the substrate. The second gap is defined by the upper surface and the second extension of the concave prescription lens.

In another embodiment, a method for forming eye-pieces is provided. The method includes overlaying a plurality of wafer protective coatings (WPCs) on a first surface of a plurality of waveguides disposed on a substrate, aligning the substrate in a tool, and depositing and curing a lens material on the plurality of WPCs. The lens material forming a plurality of convex prescription lenses on the first surface of the waveguides. The method further includes removing the WPCs from between the waveguides and prescription lens forming a first gap, and repeating overlaying to removing to form a plurality of concave prescription lenses on a second surface of the waveguide. The convex prescription lens and the concave prescription lens form a plurality of eye-pieces. The second surface is opposite the first surface. The method further includes cutting the eye-pieces from the substrate.

In another embodiment, a method for forming eye-pieces is provided. The method includes aligning a substrate in a tool, depositing a first gap-fill material on a first surface of a plurality of waveguides disposed in the substrate, and depositing and curing a lens material on the first gap-fill material. The lens material forms a plurality of convex prescription lenses on the first surface of the waveguides. The method further includes repeating overlaying to form a plurality of concave prescription lenses on a second surface of the waveguides. The convex prescription lens and the concave prescription lens form a plurality of eye-pieces. The second surface is opposite the first surface. The method further includes cutting the eye-pieces from the substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a perspective, frontal view of a waveguide, according to embodiments.

FIG. 1B is a cross-sectional view of an eye-piece, according to embodiments.

FIG. 1C is a cross-sectional view of a gap fill material eye-piece, according to embodiments.

FIG. 2 is a flow diagram describing a method of forming the eye-pieces, according to embodiments

FIGS. 3A-3Q are views of a substrate during the method of forming the eye-pieces, according to embodiments.

FIG. 4 is a flow diagram describing a method of forming a gap fill material eye-piece, according to embodiments.

FIGS. 5A-5N are views of a substrate during the method of forming the gap fill material eye-piece, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to augmented reality (AR) displays. More specifically, embodiments described herein relate to AR waveguides with attached prescription lenses. Eye-pieces to be used for AR contain AR displays using waveguides. Users that use prescription lenses to see normally will require prescription lenses in the eye-pieces. The described methods reduce the complexity of the manufacturing process of the AR waveguides with attached prescription lenses. The methods can also improve the throughput therefore reducing the cost of the process.

Current methods include overlaying pre-fabricated prescription lenses on a first and second surface of a waveguide. The current method has complex alignment procedures and a gluing process. The gluing process holds the prescription lenses to the waveguide. The gluing process has dedicated machines raising the throughput and cost. The present disclosure describes methods that allow for monolithic integration with a plurality of prescription lenses being overlaid onto a plurality of waveguides formed from a wafer. Therefore, the methods remove the gluing process and reduce the number of alignment procedures. Benefits of the methods include no complex alignment procedures for each individual waveguide, protection of the waveguide structures by the prescription lens during cutting, and customization of corrective vision prescriptions for each prescription lens on each waveguide on the wafer.

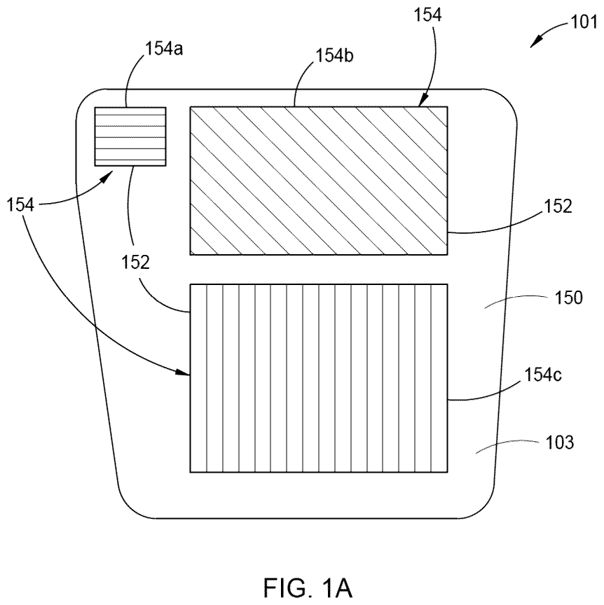

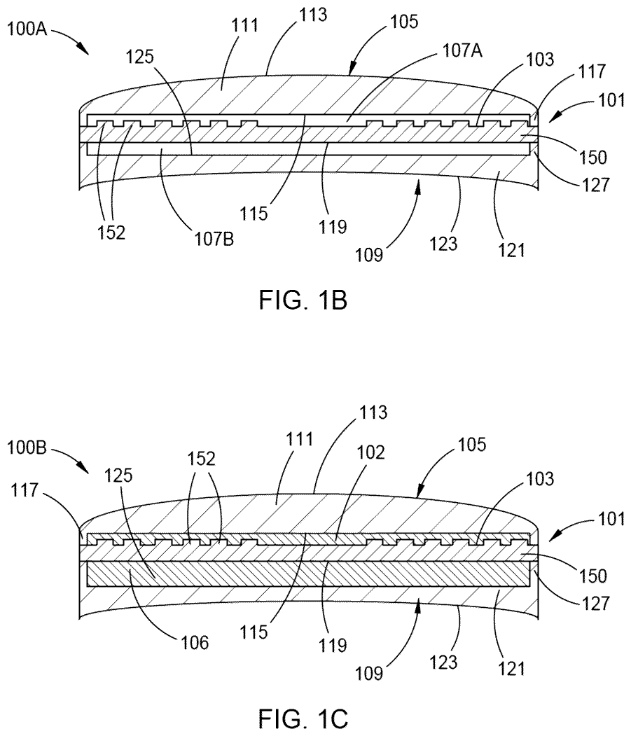

FIG. 1A is a perspective, frontal view of a waveguide 101. It is to be understood that the waveguide 101 described herein is an exemplary waveguide and that other waveguides may be used with or modified to accomplish aspects of the present disclosure. The waveguide 101 includes a plurality of structures 152. The structures 152 may be disposed over, under, or on a first surface 103 of a substrate 150, or disposed in the substrate 150. The structures 152 are nanostructures and have a sub-micron critical dimension, e.g., a width less than 1 micrometer. Regions of the structures 152 correspond to one or more gratings 154. In one embodiment, which can be combined with other embodiments described herein, the waveguide 101 includes at least a first grating 154a corresponding to an input coupling grating and a third grating 154c corresponding to an output coupling grating. In another embodiment, which can be combined with other embodiments described herein, the waveguide 101 further includes a second grating 154b. The second grating 154b corresponds to a pupil expansion grating or a fold grating.

FIG. 1B is a cross-sectional view of an eye-piece 100A. The eye-piece 100A includes the waveguide 101, a first gap 107A, a convex prescription lens 105, a second gap 107B, and a concave prescription lens 109. It is to be understood that the waveguide 101 described herein is an exemplary waveguide and that other waveguides may be used with or modified to accomplish aspects of the present disclosure. The waveguide 101 is formed from the substrate described in FIGS. 1A, 2, and 5. The waveguide 101 may include, a plastic material, a metal oxide material, silicon carbide (SiC), lithium niobate (LiNbO₃), or combinations thereof. The metal oxide material includes but it not limited to, lanthanum oxide (LaₓO_{y}), titanium oxide (TiOₓ), niobium oxide (NbOₓ), zirconium oxide (ZrOₓ), or a combinations thereof. The plastic material includes, polycarbonates (PC), polyethylene terephthalate (PET), a high index resin (greater than 2.0), or a combinations thereof. The waveguide 101 has a refractive index of about 1.5 to about 2.6.

The convex prescription lens 105 and the concave prescription lens 109 include at least one of a UV-curable acrylate, a UV-curable epoxy, a UV-curable oxetane, a UV-curable silicone, a UV-curable thiol-ene, or combinations thereof. A binary curing system may be utilized. The convex prescription lens 105 is disposed over the first surface 103 of the waveguide 101. The convex prescription lens 105 has a first body 111. The first body 111 includes a convex surface 113 and a lower surface 115. The first body 111 is surrounded by a first extension 117. The first extension 117 is disposed on the first surface 103 of the substrate 150. The first gap 107A is defined by the lower surface 115, the first surface 103 of the waveguide 101 and the first extension 117 of the convex prescription lens 105. A second surface 119 of the substrate 150 is disposed over the concave prescription lens 109. The second surface 119 is opposite the first surface 103. The concave prescription lens 109 has a second body 121. The second body 121 includes a concave surface 123 and an upper surface 125. A second extension 127 surrounds the second body 121. The second surface 119 of the substrate 150 is disposed on the second extension 127. The second gap 107B is defined by the upper surface 125, the second surface 119 of the waveguide 101, and the second extension 127 of the concave prescription lens 109.

The convex prescription lens 105 faces a world side of the resulting AR display i.e. the side away from the user. The concave prescription lens 109 faces the eye side of the resulting AR display i.e. the side facing the user's eye. The concave prescription lens 109 provides optical correction to the user as a traditional corrective prescription lens. However, the concave prescription lens 109 has a higher optical power than the prescription normally required by the user. The higher optical power of the waveguide 101 ensures that the virtual image is properly displayed. The concave prescription lens 109 allows a virtual image to appear at the proper distance from the user. Without the concave prescription lens 109, the virtual image would be projected at an infinite focal distance. The convex prescription lens 105 corrects the prescription of the concave prescription lens 109 in order to match the prescription normally required by the user by counteracting a portion of the optical power provided by the concave prescription lens 109. In some embodiments, the eye-piece 100A can be used by a user without a prescription lens by the convex prescription lens 105 counteracting all the optical power of the concave prescription lens 109. The convex prescription lens 105 causes the world images to appear corrected as they would be in a traditional corrective prescription lens. For example, for a user not needing prescription lenses, the concave prescription lens 109 will have a prescription of −2 diopter and the convex prescription lens 105 will have a prescription lens of +2 diopter, combined for an eye-piece with no correction of the users vision. For users with myopia, the concave prescription lens 109 will have a prescription of −2 diopter and the convex prescription lens 105 will have a prescription lens of +1 diopter, combined to provide −1 diopter optical power for eye-sight correction. The corrective effect of the convex prescription lens 105 and the concave prescription lens 109 is determined by the shape of the convex prescription lens 105 the concave prescription lens 109. The convex prescription lens 105 and the concave prescription lens 109 protect the nanostructures of the waveguide 101 from contaminates.

The first gap 107A includes air. The convex prescription lens 105 has a refractive index of about 1.5 to about 1.8. The first gap 107A has the refractive index of air. Air has a refractive index of about 1.0. The first gap 107A optically isolates the waveguide 101 from the convex prescription lens 105. The optical isolation of the waveguide 101 and the convex prescription lens 105 is caused by the first gap 107A having a lower refractive index compared to the waveguide 101 and convex prescription lens 105. The waveguide 101 and convex prescription lens 105 are optically isolated in order for the waveguide 101 to function properly. The second gap 107B includes air. The concave prescription lens 109 has a refractive index of 1.5 to 1.8. The second gap 107B has the refractive index of air. The second gap 107B optically isolates the waveguide 101 from the concave prescription lens 109. The optical isolation of the waveguide 101 and the concave prescription lens 109 is caused by the second gap 107B having a lower refractive index compared to the waveguide 101 and concave prescription lens 109. The waveguide 101 and the concave prescription lens 109 are optically isolated in order for the waveguide 101 to function properly.

FIG. 1C is a cross-sectional view of a gap fill material eye-piece 100B. The gap fill material eye-piece 100B includes the waveguide 101, a first gap-fill material 102, the convex prescription lens 105, a second gap-fill material 106, and the concave prescription lens 109. The first gap 107A is filled with the first gap-fill material 102. The first gap-fill material 102 is disposed between the waveguide 101 and the convex prescription lens 105. The second gap 107B is filled with second gap-fill material 106. The second gap-fill material 106 is disposed between the waveguide 101 and the concave prescription lens 109. The first gap-fill material 102 and the second gap-fill material 106 include a low refractive index material such as a porous inorganic or porous organic material.

The first gap-fill material 102 has a refractive index of 1.03 to 1.4. The first gap-fill material 102 has a refractive index less than the material of the convex prescription lens 105 and the concave prescription lens 109. The first gap-fill material 102 optically isolates the waveguide 101 from the convex prescription lens 105. The optical isolation of the waveguide 101 and the convex prescription lens 105 is caused by the first gap-fill material 102 having a lower refractive index compared to the waveguide 101 and the convex prescription lens 105. The waveguide 101 and the convex prescription lens 105 are optically isolated in order for the waveguide 101 to function properly. The second gap-fill material 106 has a refractive index of 1.03 to 1.4. The second gap-fill material 106 has a refractive index less than the material of the convex prescription lens 105 and the concave prescription lens 109. The second gap-fill material 106 optically isolates the waveguide 101 from the concave prescription lens 109. The optical isolation of the waveguide 101 and the concave prescription lens 109 is caused by the second gap-fill material 106 having a lower refractive index compared to the waveguide 101 and the concave prescription lens 109. The gap fill material eye-piece 100B functions in the same way as the eye-piece 100A as described above in FIG. 1B.

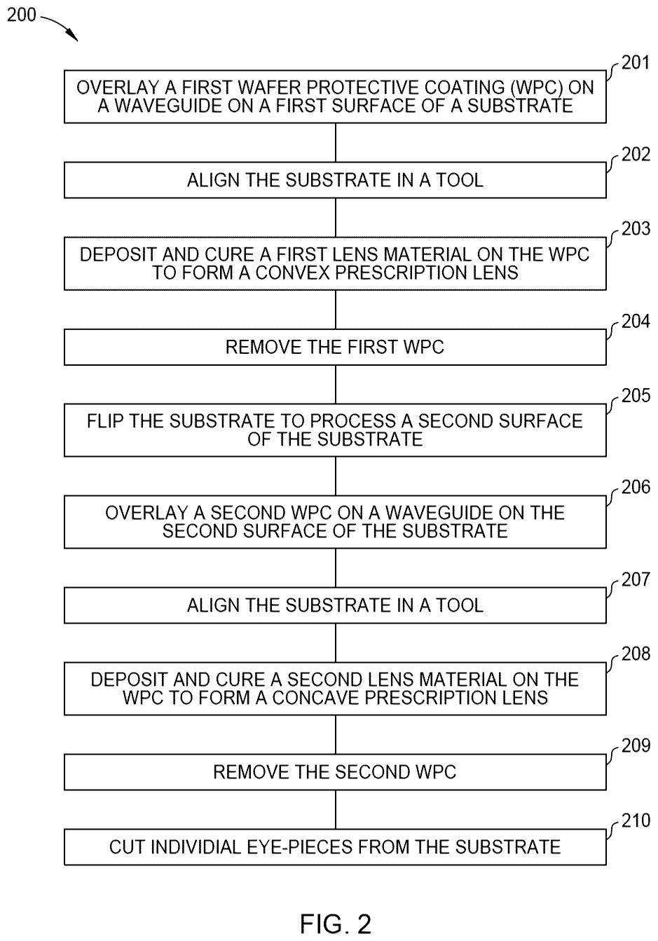

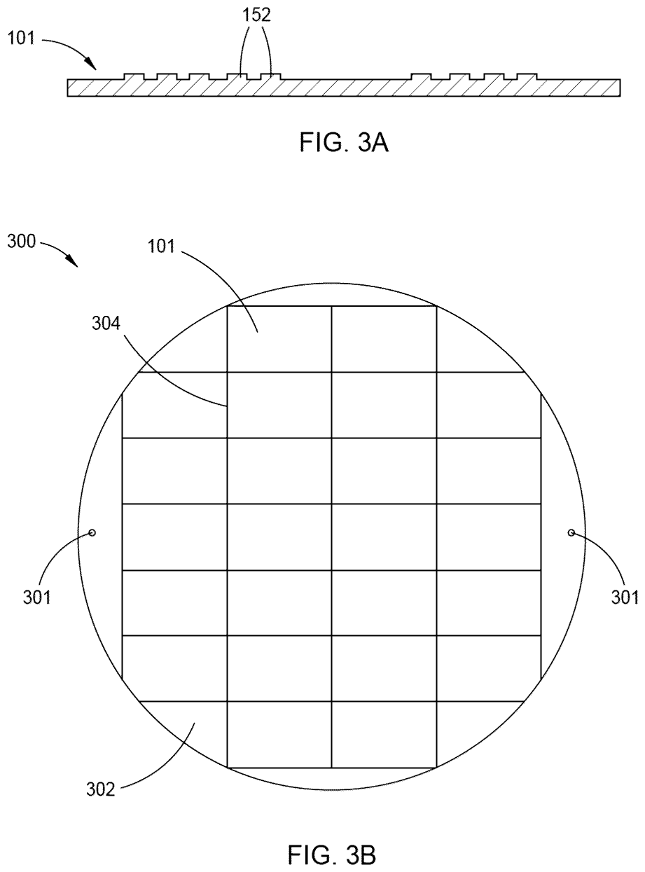

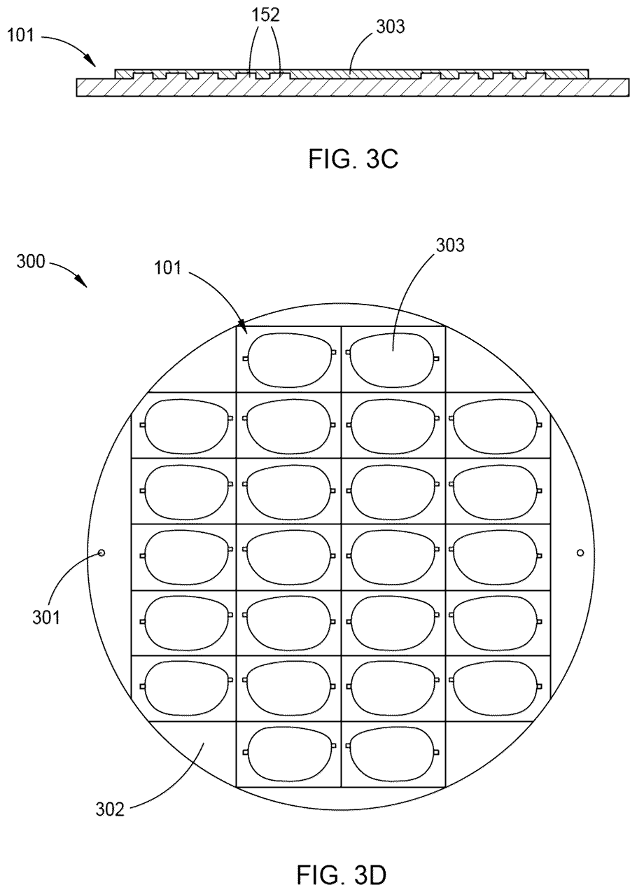

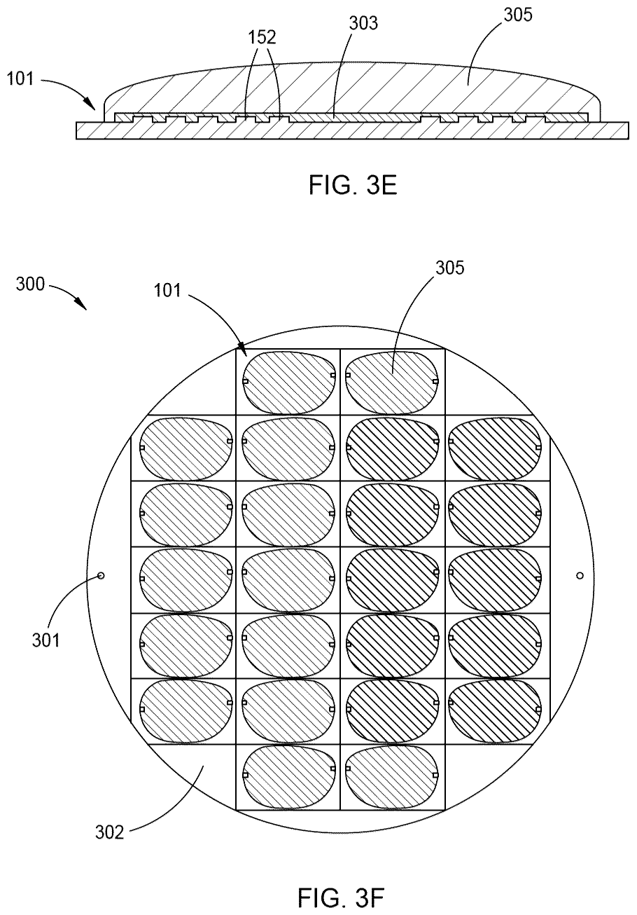

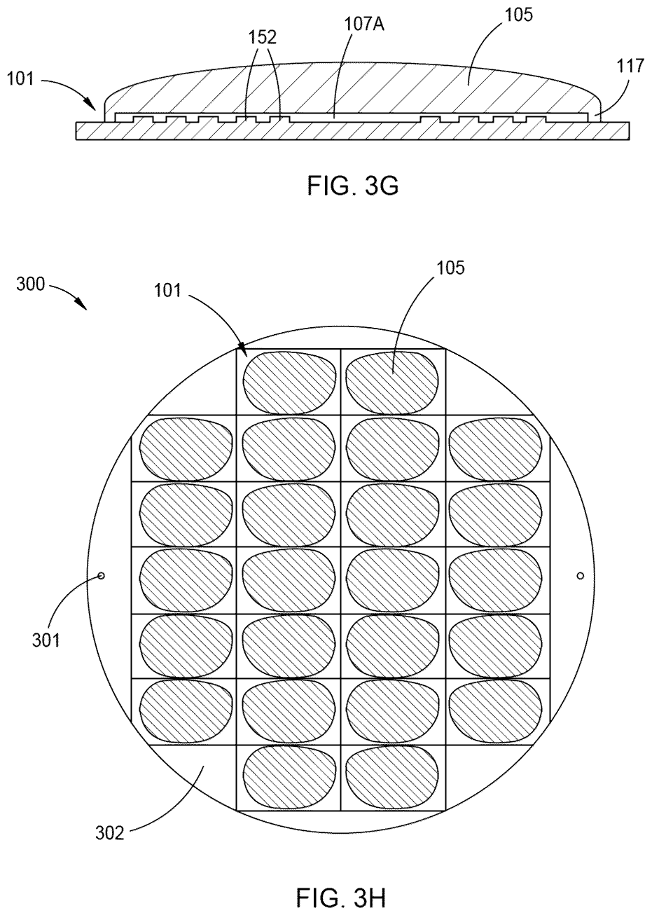

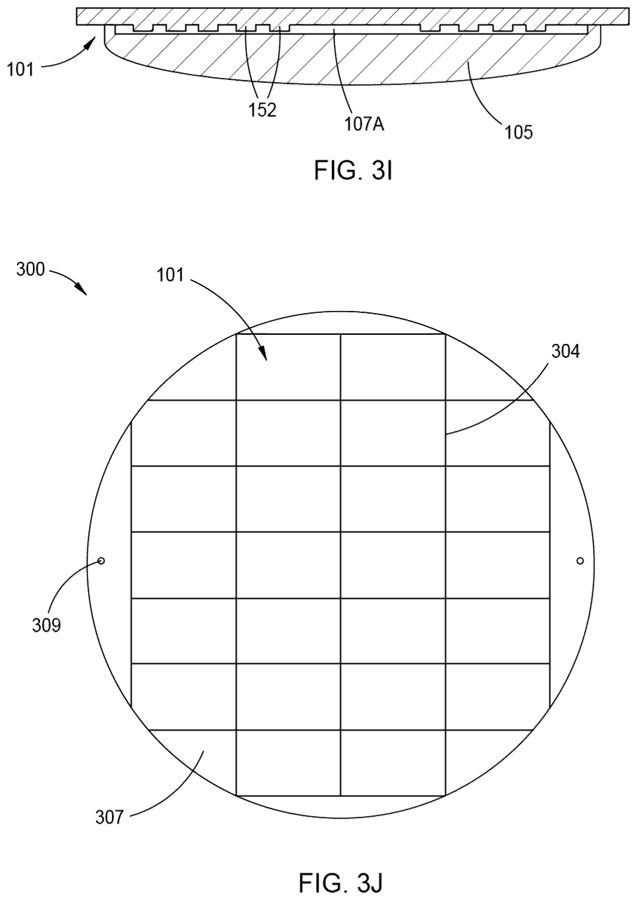

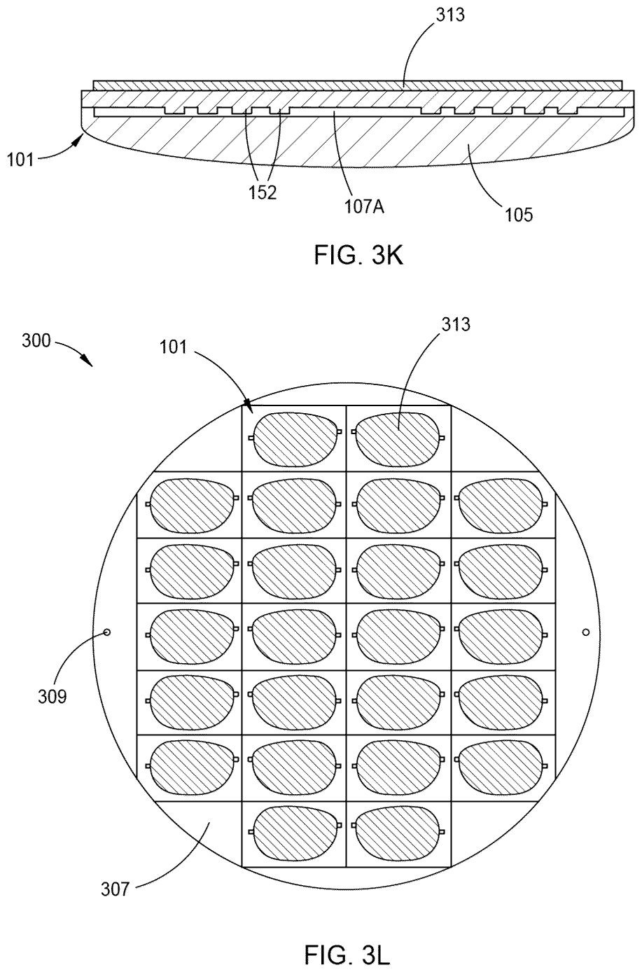

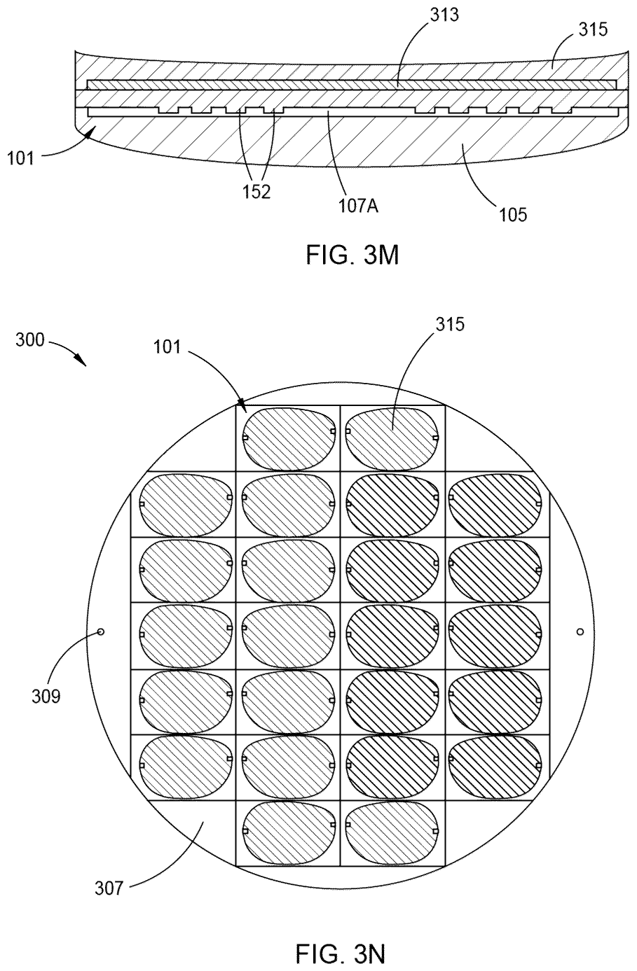

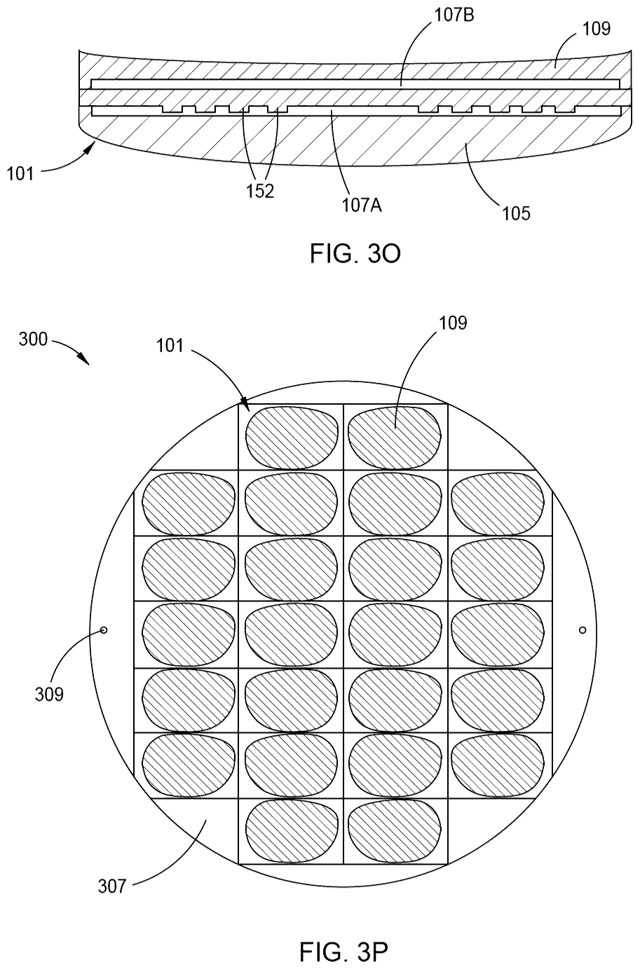

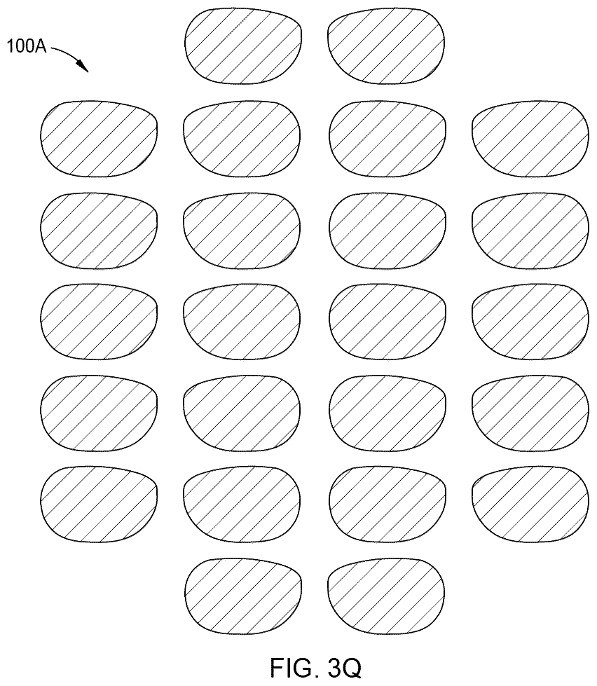

FIG. 2 is a flow diagram describing a method 200 of forming the eye-pieces 100A. FIGS. 3A-3Q are views of a substrate 300 during the method of forming the eye-pieces 100A. FIG. 3A is a cross-sectional view of the waveguide 101 at the beginning of method 200. The waveguide 101 includes a plurality of structure 152. The structures 152 are nanostructures and have a sub-micron critical dimension, e.g., a width less than 1 micrometer. Regions of the structures 152 correspond to one or more gratings. FIG. 3B is a top view of the substrate 300 at the beginning of method 200. A plurality of the waveguides 101 are formed on, over, or in a substrate 300. The substrate 300 has a first surface 302. The substrate 300 may include 20 to 30 waveguides, such as 24 waveguides. In other embodiments, different number of waveguides 101 are formed with the substrate 300. Rectangular dice marks 304 indicate the regions where the waveguides 101 are formed in the substrate 300. The waveguides 101 will be diced from the substrate 300 at the end of the process. The substrate 300 has two alignment points 301 on the first surface 302 to align the substrate 300 in process chambers and tools

At operation 201, as shown in FIG. 3C and FIG. 3D, a plurality of first wafer protective coatings (WPCs) 303 are overlaid on the plurality of waveguides 101 on the first surface 302 of the substrate 300. FIG. 3C is a cross-sectional view of the waveguide 101 at operation 201. FIG. 3D is a top view of the waveguide 101 at operation 201. The WPCs are disposed on the first surface 302 of the substrate 300. In some embodiments, the first WPCs 303 are printed on each waveguide 101. In other embodiments, the first WPCs 303 are prefabricated and placed on top of each waveguide 101. The first WPCs 303 include a water-soluble material, a water-soluble polymer, a heat decomposable material, a UV decomposable material, a solvent strippable material, or a sacrificial layer.

At operation 202, the substrate 300 is aligned in a tool. The alignment points 301 are used to verify the substrate 300 is in the correct position in the tool. The tool will be used to form the prescription lenses. The tool may be any suitable tool such as a three dimensional printing tool. In some embodiments, multiple tools are used during the method 200. In those embodiments, the substrate 300 is aligned in each tool prior to the operation being performed. In some, embodiments, the substrate 300 is aligned prior to the first WPC 303 being overlaid on the plurality of waveguides 101.

At operation 203, as shown in FIG. 3E and FIG. 3F, a lens material 305 is deposited and cured on the first WPCs 303 to form a convex prescription lens 105. FIG. 3E is a cross-sectional view of the waveguide 101 at operation 203. FIG. 3F is a top view of the waveguide 101 at operation 203. The lens material 305 is deposited on each first WPCs 303 above each waveguide 101 layer by layer. The lens material 305 is deposited by inkjet printing. The lens material 305 is cured after each layer is deposited. The lens material 305 may be UV light curable or visible light curable. In some embodiments, the curing process includes a post-UV thermal annealing process. The lens material 305 creates a convex shape. After the final layer of the lens material 305 is cured, the lens material 305 forms the convex prescription lens 105.

At operation 204, as shown in FIG. 3G and 3H, the first WPCs 303 are removed. FIG. 3G is a cross-sectional view of the waveguide 101 at operation 204. FIG. 3H is a top view of the waveguide 101 at operation 204. In some embodiments, the first WPCs 303 are removed by soaking in water. The first WPCs 303 are water-soluble. The convex prescription lens 105 includes a first extension 117. Small trenches exist in the first extension 117 of the convex prescription lenses 105 that allow the water to access the first WPCs 303. The water dissolves the first WPCs 303 allowing the material to be removed from between the convex prescription lens 105 and the waveguide 101 through the small trenches. In other embodiments, the first WPCs 303 are removed by different processes. When the first WPCs 303 are removed, the first gaps 107A are formed between the waveguides 101 and the convex prescription lenses 105. In some embodiments, after the first WPCs 303 are removed, the small trenches are filled with lens material 305 and cured. In some embodiments, after forming the convex prescription lens 105, the method 200 may proceed to operation 210 (i.e., the concave prescription lens 109 is not formed on the waveguide 101). In other embodiments, the method 200 may begin at operation 205. (i.e., the convex prescription lens 105 is not formed on the waveguide 101).

At operation 205, as shown in FIG. 3I and FIG. 3J, the substrate 300 is flipped to process a second surface 307 of the substrate 300. The second surface 307 is opposite the first surface 302 of the substrate 300. FIG. 3I is a cross-sectional view of the waveguide 101 at operation 205. FIG. 3J is a top view of the waveguide 101 at operation 205. The waveguides 101 formed in the substrate 300 are separated by rectangular dice marks 304. Second alignment points 309 are disposed on the substrate 300 on the second surface 307 to align the substrate 300 in process chambers and tools.

At operation 206, as shown in FIG. 3K and FIG. 3L, a plurality of second wafer protective coatings (WPCs) 313 are overlaid on the plurality of waveguides 101 on the second surface 307 of the substrate 300. FIG. 3K is a cross-sectional view of the waveguide 101 at operation 206. FIG. 3L is a top view of the waveguide 101 at operation 206. The second WPCs 313 are disposed on the second surface 307 of the substrate 300. In some embodiments, the second WPCs 313 are printed on each waveguide 101. In other embodiments, the second WPCs 313 are prefabricated and placed on top of each waveguide 101. The second WPCs 313 include a water-soluble material, a water-soluble polymer, a heat decomposable material, a UV decomposable material, a solvent strippable material, or a sacrificial layer.

At operation 207, the substrate 300 is aligned in a tool. The alignment points 309 are used to verify the substrate 300 is in the correct position in the tool. In some embodiments, the substrate 300 is aligned prior to the second WPC 313 being overlaid on the plurality of waveguides 101.

At operation 208, as shown in FIG. 3M and FIG. 3N, a second lens material 315 is deposited and cured on the second WPCs 313 on the second surface 307 of the substrate 300. FIG. 3M is a cross-sectional view of the waveguide 101 at operation 208. FIG. 3N is a top view of the waveguide 101 at operation 208. The second lens material 315 is deposited on each second WPCs 313 above each waveguide 101 layer by layer. The second lens material 315 is deposited by inkjet printing. The second lens material 315 is cured after each layer is deposited. The second lens material 315 may be UV light curable or visible light curable. In some embodiments, the curing process includes a post-UV thermal annealing process. The second lens material 315 creates a concave shape. After the final layer of the second lens material 315 is cured, the second lens material 315 forms the concave prescription lenses 109.

At operation 209, as shown in FIGS. 3O and 3P, the second WPCs 313 are removed. FIG. 3O is a cross-sectional view of the waveguide 101 at operation 209. FIG. 3P is a top view of the waveguide 101 at operation 209. In some embodiments, the second WPCs 313 are removed by soaking in water. The second WPCs 313 are water-soluble. The concave prescription lens 109 includes a second extension 127. Small trenches exist in the second extension 127 of the concave prescription lenses 109 that allow the water to access the second WPCs 313. The water dissolves the second WPCs 313 allowing the material to be removed from between the concave prescription lens 109 and the waveguide 101 through the small trenches. In other embodiments, the second WPCs 313 are removed by different processes. When the second WPCs 313 are removed, the second gaps 107B are formed between the waveguides 101 and the concave prescription lenses 109. In some embodiments, after the second WPCs 313 are removed, the small trenches are filled with lens material 315 and cured.

At operation 210, as shown in FIG. 3Q, individual eye-pieces 100A are cut from the substrate 300. The eye-pieces 100A are cut by a separate tool using a laser. In some embodiments, the laser is a laser for cutting glass.

In some embodiments, the substrate 300 is aligned once or twice on both the first surface 302 and the second surface 307 for a maximum four times. If fabricating 24 eye-pieces, traditional processes require at least 48 alignments, one for each side of each eye-piece. The method 200 reduces the amount of alignments from 48 to 4.

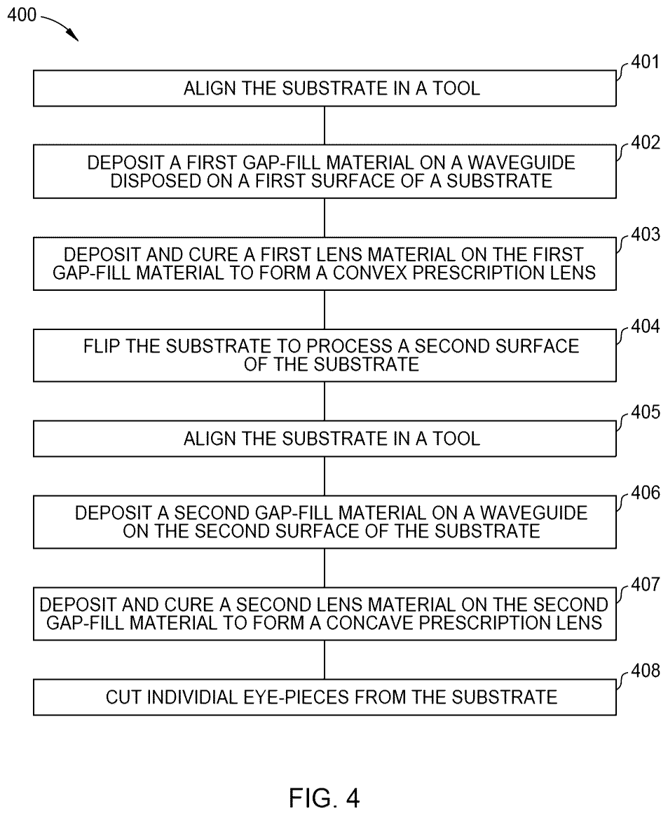

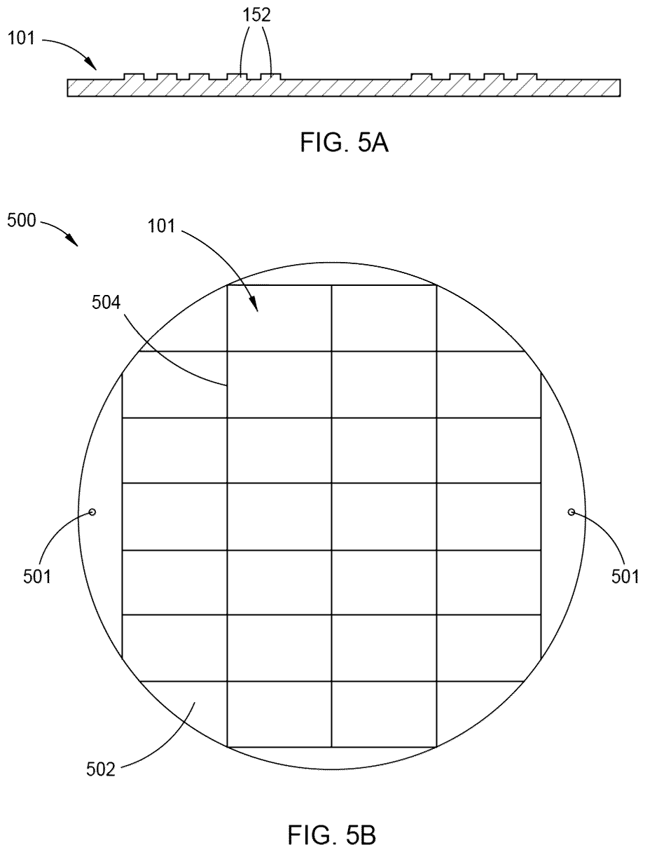

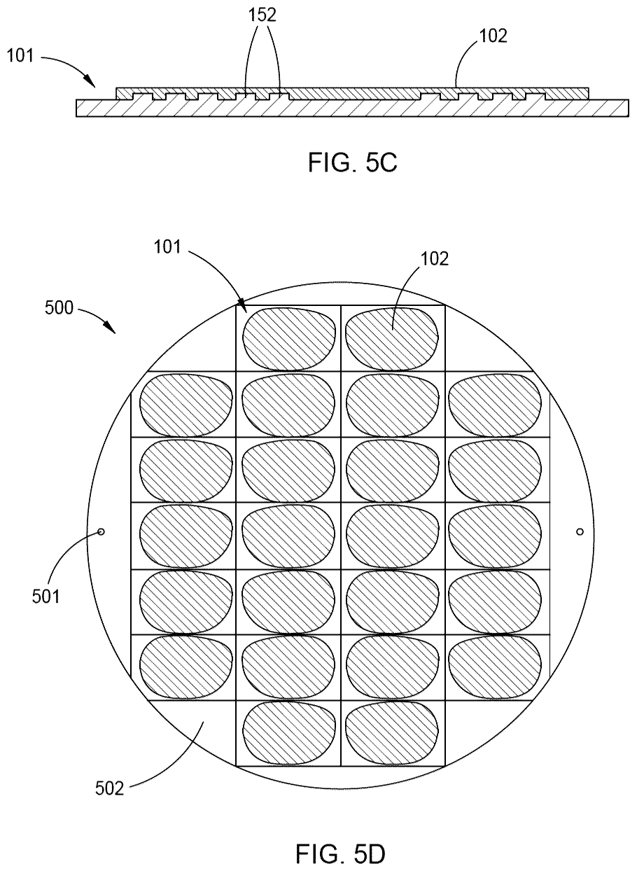

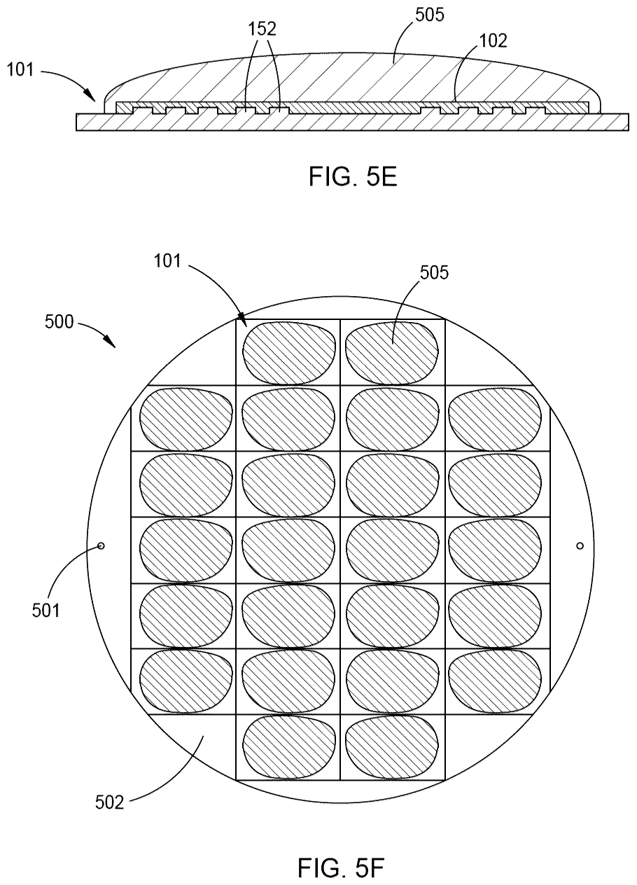

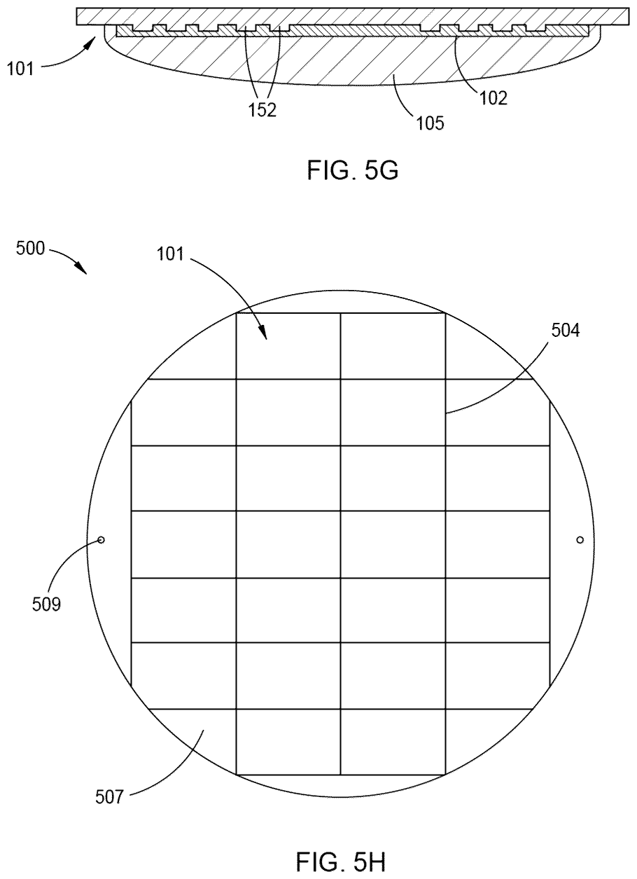

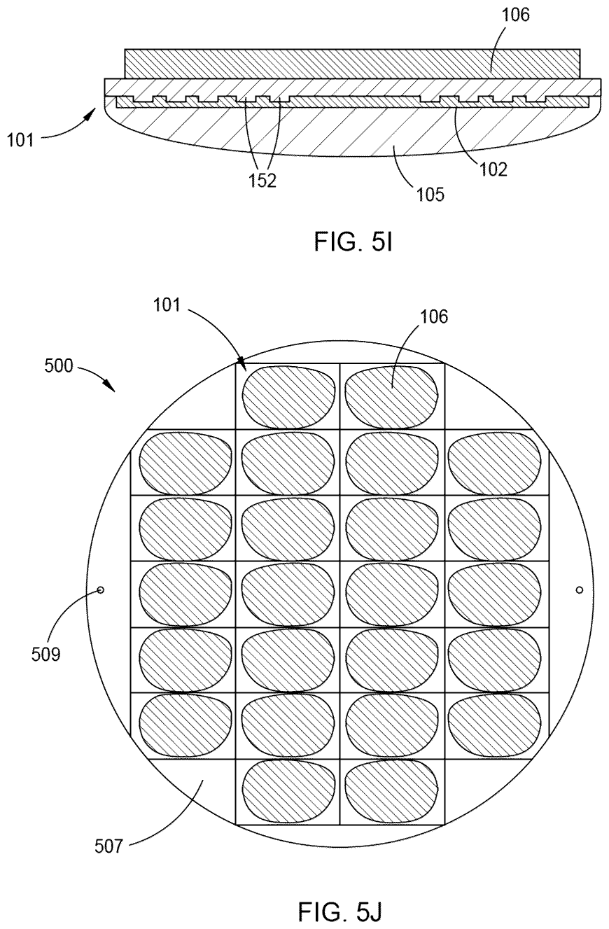

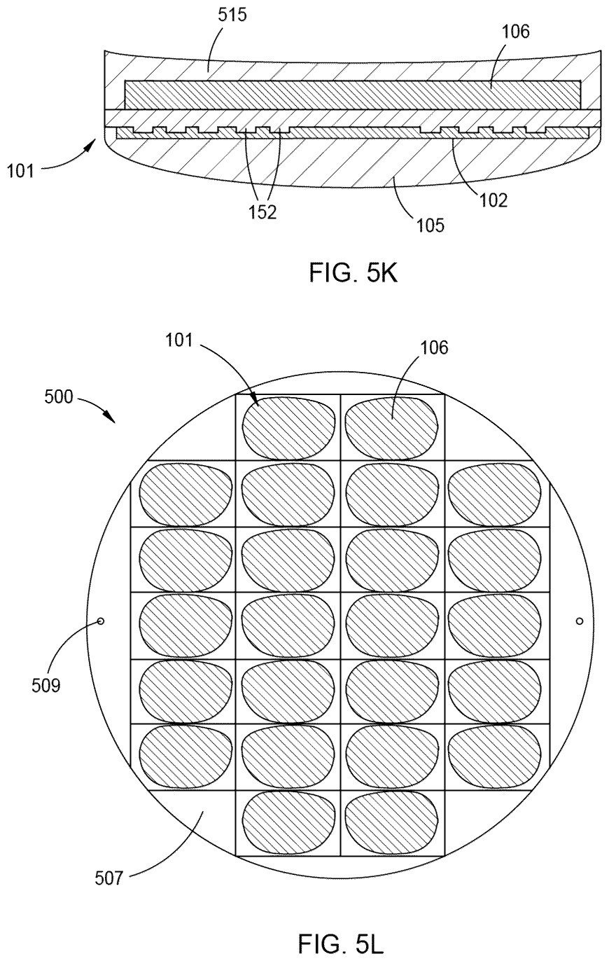

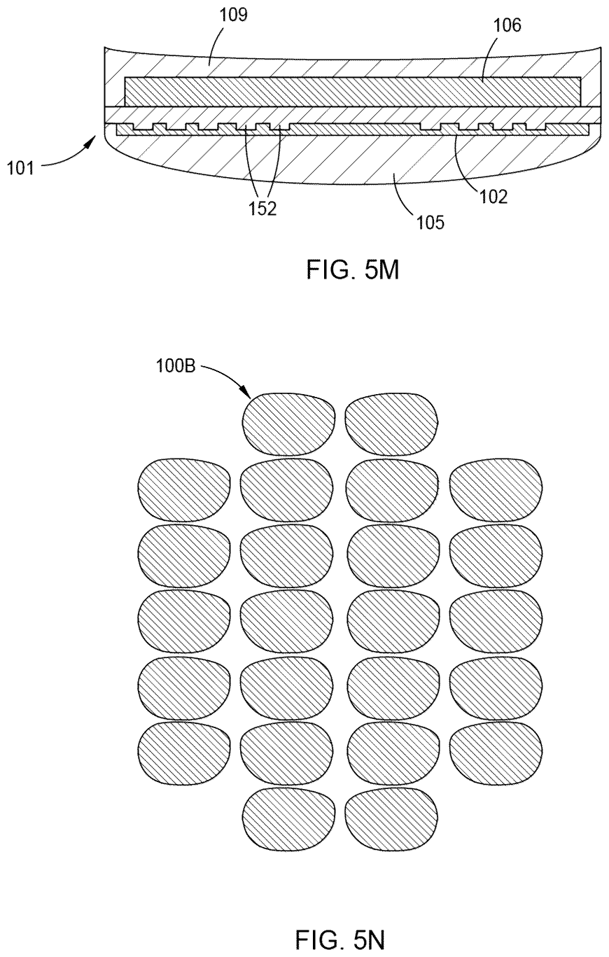

FIG. 4 is a flow diagram describing a method 400 of forming a gap fill material eye-piece 100B. FIG. 5A-5N are views of a substrate 500 during the method 400 of forming the gap fill material eye-piece 100B. FIG. 5A is a cross-sectional view of the waveguide 101 at the beginning of method 400. The waveguide 101 includes a plurality of structure 152. The structures 152 are nanostructures and have a sub-micron critical dimension, e.g., a width less than 1 micrometer. Regions of the structures 152 correspond to one or more gratings. FIG. 5B is a top view of the substrate 500 at the beginning of method 400. A plurality of the waveguides 101 are formed on, over, or in a substrate 500. The substrate 500 has a first surface 302. The substrate 500 may include 20 to 30 waveguides, such as 24 waveguides. In other embodiments, different number of waveguides 101 are formed with the substrate 500. Rectangular dice marks 504 indicate the regions where the waveguides 101 are formed in the substrate 500. The waveguides 101 will be diced from the substrate 500 at the end of the process. The substrate 500 has two alignment points 501 on the first surface 502 to align the substrate 500 in process chambers and tools.

At operation 501, the substrate 500 is aligned in the tool. The alignment points 501 are used to verify the substrate 500 is in the correct position in the tool. The tool will be used to form the prescription lens and cut the gap fill material eye-pieces 100B out of the substrate 500. The tool may be any suitable tool such as a three dimensional printing tool. In some embodiments, separate tools are used to form the prescription lens and cut the gap fill material eye-pieces 100B. In those embodiments, the substrate 500 is aligned in each tool prior to the process.

At operation 402, as shown in FIG. 5C and FIG. 5D, the first gap-fill material 102 is deposited on the plurality of waveguides 101. The first gap-fill material 102 is disposed on the first surface 502 of the substrate 500. The first gap-fill material 102 is deposited by inkjet printing on each waveguide 101. The first gap-fill material 102 is cured after each layer is deposited. The first gap fill material 102 is cured at a temperature of about 50° C. to about 300° C.

At operation 403, as shown in FIG. 5E and FIG. 5F, a first lens material 505 is deposited and cured on the first gap-fill material 102 to form a convex prescription lens 105. FIG. 5E is a cross-sectional view of the waveguide 101 at operation 403. FIG. 5F is a top view of the waveguide 101 at operation 403. The first lens material 505 is deposited on each first gap-fill material 102 above each waveguide 101 layer by layer. The first lens material 505 is deposited by inkjet printing. The first lens material 505 is cured after each layer is deposited. The first lens material 505 may be UV light curable or visible light curable. In some embodiments, the curing process includes a post-UV thermal annealing process. The first lens material 505 creates a convex shape. After the final layer of the first lens material 505 is cured, the first lens material 505 forms the convex prescription lens 105. In some embodiments, after forming the convex prescription lens 105, the method 400 may proceed to operation 408 (i.e., the concave prescription lens 109 are not formed on the waveguide 101). In other embodiments, the method 400 may begin at operation 404. (i.e., the convex prescription lens 105 is not formed on the waveguide 101).

At operation 404, as shown in FIG. 5G and FIG. 5H, the substrate 500 is flipped to process a second surface 507 of the substrate 500. The second surface 507 is opposite the first surface 502 of the substrate 500. FIG. 5G is a cross-sectional view of the waveguide 101 at operation 404. FIG. 5H is a top view of the waveguide 101 at operation 404. The waveguides 101 formed in the substrate 500 are separated by rectangular dice marks 504. Second alignment points 509 are disposed on the substrate 500 on the second surface 507 to align the substrate 500 in process chambers and tools.

At operation 405, the substrate 500 is aligned in a tool. The alignment points 509 are used to verify the substrate 500 is in the correct position in the tool. In some embodiments, the substrate 500 is aligned prior to a second fill material 106 being overlaid on the plurality of waveguides 101.

At operation 406, as shown in FIG. 5I and FIG. 5J, the second fill material 106 is overlaid on the plurality of waveguides 101 on the second surface 507 of the substrate 500. FIG. 5I is a cross-sectional view of the waveguide 101 at operation 406. FIG. 5J is a top view of the waveguide 101 at operation 406. The second fill material 106 is disposed on the second surface 507 of the substrate 500. In some embodiments, second fill material 106 is inkjet printed on each waveguide 101. The second gap-fill material 106 is cured after each layer is deposited. The second gap fill material 106 is cured at a temperature of about 50° C. to about 300° C.

At operation 407, as shown in FIG. 5K and FIG. 5L, a second lens material 515 is deposited and cured on the second fill material 106 on the second surface 507 of the substrate 500. FIG. 5K is a cross-sectional view of the waveguide 101 at operation 407. FIG. 5L is a top view of the waveguide 101 at operation 407. The second lens material 515 is deposited on the second fill material 106 above each waveguide 101 layer by layer. The second lens material 515 is deposited by inkjet printing. The second lens material 515 is cured after each layer is deposited. The second lens material 515 may be UV light curable or visible light curable. In some embodiments, the curing process includes a post-UV thermal annealing process. The second lens material 515 creates a concave shape. After the final layer of the second lens material 515 is cured, the second lens material 515 forms the concave prescription lenses 109.

At operation 408, as shown in FIG. 5M and FIG. 5N, individual eye-pieces 100A are cut from the substrate 500. The eye-pieces 100A are cut by a separate tool using a laser. In some embodiments, the laser is a laser for cutting glass.

In some embodiments, the substrate 500 is aligned once or twice on both the first surface 502 and the second surface 507 for a maximum four times. If fabricating 24 eye-pieces, traditional processes require at least 48 alignments, one for each side of each eye-piece. The method 400 reduces the amount of alignments from 48 to 4.

In summation, present disclosure generally relates to augmented reality (AR) displays. More specifically, embodiments described herein relate to AR waveguides with attached prescription lens. The embodiments include methods allowing monolithic integration with a plurality of prescription lenses being overlaid onto a plurality of waveguides formed from a wafer. Therefore, the methods remove the gluing process and reduces the amount of alignment procedures. Other benefits include no complex alignment procedures for each individual waveguide due to the eye-pieces being made in batches on the substrate. The corrective prescriptions for each prescription lens on each waveguide may be customized on the substrate due to the process used to form the prescription lenses.

While the foregoing is directed to embodiments of the present disclosure, other and further embodiments of the disclosure may be devised without departing from the basic scope thereof, and the scope thereof is determined by the claims that follow.

What is claimed is:

1. A lens, comprising:
a waveguide comprising a substrate with a first surface and a second surface;
a convex prescription lens disposed over the waveguide, the convex prescription lens having a first body with a convex surface and a lower surface;
a first gap defined by the lower surface and the first surface of the waveguide;
a concave prescription lens disposed over the waveguide, the concave prescription lens having a second body with a concave surface and an upper surface; and
a second gap defined by the upper surface and the second surface of the waveguide.

2. The lens of claim 1, wherein:
a first gap-fill material is disposed in the first gap; and
a second gap-fill material is disposed in the second gap.

3. The lens of claim 2, wherein the first gap-fill material and the second gap fill material have a refractive index of 1.03 to 1.4.

4. The lens of claim 2, wherein the waveguide comprises silicon carbide, lithium niobate, lanthanum oxide, titanium oxide, niobium oxide, zirconium oxide, polycarbonates, or polyethylene terephthalate.

5. The lens of claim 1, wherein the waveguide has a refractive index of 1.5 to 2.6 and includes gratings corresponding to an input coupling grating, a pupil expansion grating, and an output coupling grating.

6. The lens of claim 1, wherein the convex prescription lens and the concave prescription lens comprise UV-curable acrylate, a UV-curable epoxy, a UV-curable oxetane, a UV-curable silicone, or a UV-curable thiol-ene.

7. The lens of claim 1, wherein the convex prescription lens and the concave prescription lens have a refractive index of 1.5 to 1.8.

8. The lens of claim 1, wherein the first gap and the second gap comprise air.

9. A method for forming lenses, comprising:
overlaying a plurality of wafer protective coatings (WPCs) on a first surface of a plurality of waveguides disposed on a substrate;
aligning the substrate in a tool;
depositing and curing a lens material on the plurality of wafer protective coatings forming a plurality of convex prescription lenses on the first surface of the waveguides; and
cutting the lenses from the substrate.

10. The method of claim 9, further comprising:
removing the WPCs from between the waveguides and prescription lens forming a first gap.

11. The method of claim 9, further comprising:
repeating overlaying to cutting to form a plurality of concave prescription lenses on a second surface of the waveguide forming a plurality of lenses, the second surface being opposite the first surface.

12. The method of claim 9, wherein the lens material comprises UV-curable acrylate, a UV-curable epoxy, a UV-curable oxetane, a UV-curable silicone, or a UV-curable thiol-ene.

13. The method of claim 9, wherein the WPCs may be printed on or attached to the waveguides.

14. The method of claim 13, wherein the WPCs are removed by soaking in water.

15. The method of claim 9, wherein the lenses are cut using a laser cutting tool.

16. A method for forming lenses, comprising:
aligning a substrate in a tool;
depositing a first gap-fill material on a first surface of a plurality of waveguides disposed in the substrate;
depositing and curing a lens material on the first gap-fill material forming a plurality of convex prescription lenses on the first surface of the waveguides; and
cutting the lenses from the substrate.

17. The method of claim 16, further comprising:
repeating overlaying to removing to form a plurality of concave prescription lenses on a second surface of the waveguides forming a plurality of lenses, the second surface opposite the first surface.

18. The method of claim 16, wherein the lens material comprises a UV-curable acrylate, a UV-curable epoxy, a UV-curable oxetane, a UV-curable silicone, or a UV-curable thiol-ene.

19. The method of claim 16, wherein the lens material is deposited by inkjet printing.

20. The method of claim 16, wherein the lenses are cut using a laser cutting tool.
